(19) United States
(12) Patent Application Publication
(10) Pub. No.: US 2021/0090163 A1
(43) Pub. Date: Mar. 25, 2021

(54) METHOD AND SYSTEM FOR COMPARING A TIME SERIES OF FINANCIAL MEASUREMENTS TO A BASELINE POPULATION

(71) Applicant: Zetatango Technology Inc., Ontario (CA)

(72) Inventors: Peter Rabinovitch, Ottawa (CA); Cem Sinan Ozturk, Orleans (CA); Justin Charbonneau, Gatineau (CA)

(21) Appl. No.: 16/576,881

(22) Filed: Sep. 20, 2019

(51) Int. Cl. G06Q 40/02; G06Q 10/06

(52) U.S. Cl. CPC G06Q 40/025; G06Q 10/0635

(57) ABSTRACT

Evaluating financial risk for a target business by extracting a plurality of financial factors from a financial memory. Based on applying a changepoint algorithm, determining one or more segments of financial data. Identifying one or more trends within one or more segments of financial data. Based on extrapolating one or more trends, calculating one or more figures of merit. Extracting one or more comparable figures of merit from one or more comparable business from a figure of merit memory. Transforming one or more comparable figures of merit into a baseline distribution. Based on the baseline distribution, determining a percentile for a target business. Storing the target figure of merit into a figure of merit memory.

### BACKGROUND

Presently in the financial services and loan industry, there exists a challenge in evaluating risk and determining appropriate levels of loan capital and interest. Current methods for evaluation tend to focus on the analysis of the borrower's credit score, cash flow, and other similar factors. These factors only represent past and/or current financial performance of the borrower. These factors also lack future performance considerations and a point of reference for these performances.

When estimating the risk of defaulting on the loan, important factors to consider include the size of debt burden, the loan size, the frequency of borrowing, the length of commitment, and social and community considerations. Focusing on the borrower's credit score and cash flow provide sufficient insight into the borrower's frequency but further understanding of the performance of the borrower's business is required.

Additional sources of data for the size of debt burden, the loan size and the length of commitment evaluation include borrower's expenses, such as rent and salary, sales, such as credit and cash, and revenue, such as daily or quarterly figures, or any time resolution with sufficient data. These parameters can be utilized to further determine the performance of a borrower over a period of time, enhancing the risk evaluation process. Performances of other businesses within a similar geographical location and/or industry can provide further insight into social and community influences. Additionally, a comparison of risk factors of these businesses with the borrower provides a necessary reference point and added context in interpretation of the comparison results.

There exists a need for an accurate method and system to compare a target business, through a time series of financial measurements, to a baseline of similar/differing businesses across many dimensions, in order to decide the appropriate level of capital and/or interest for a loan.

### BRIEF SUMMARY

A major aspect of the invention includes a method of evaluating the financial risk for a target business against one or more comparable businesses. The method comprises of extracting a plurality of financial data for the target business from a financial factors memory. Applying a changepoint algorithm to determine one or more segments of the financial data. Identifying one or more trends within one or more segments of the financial data. Extrapolating one of more trends to calculate one or more target figures of merit. Extracting one or more comparable figures of merit for one or more comparable businesses from a figure of merit memory. Transforming one or more comparable figures of merit into a baseline distribution. Based on the baseline distribution, determining a percentile for a target business. Storing a target figure of merit into a figure of merit memory.

In further embodiments, the financial data are comprised of a plurality of financial factors.

In other embodiments, the figure of merit is comprised of a plurality of previously calculated figures of merit.

In other embodiments, the percentiles are binned into a plurality of discrete buckets.

In other embodiments, the binned percentiles are awarded corresponding grades.

In other embodiments, the financial data is a time series.

In other embodiments, the financial data is a scalar.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a high-level system diagram in accordance with one embodiment.

FIG. 2 illustrates data flow in accordance with one embodiment.

FIG. 3 illustrates a singular figure of merit computation in accordance with one embodiment.

FIG. 4 illustrates a combined figures of merit computation in accordance with one embodiment.

FIG. 5 illustrates stable sales history in accordance with one embodiment.

FIG. 6 illustrates an unstable sales history in accordance with one embodiment.

FIG. 7 illustrates sales trends in accordance with one embodiment.

FIG. 8 illustrates sales forecasting in accordance with one embodiment.

FIG. 9 illustrates a combined algorithm system in accordance with one embodiment.

FIG. 10 illustrates a figure of merit histogram in accordance with one embodiment.

FIG. 11 illustrates a grade evaluation for target business in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

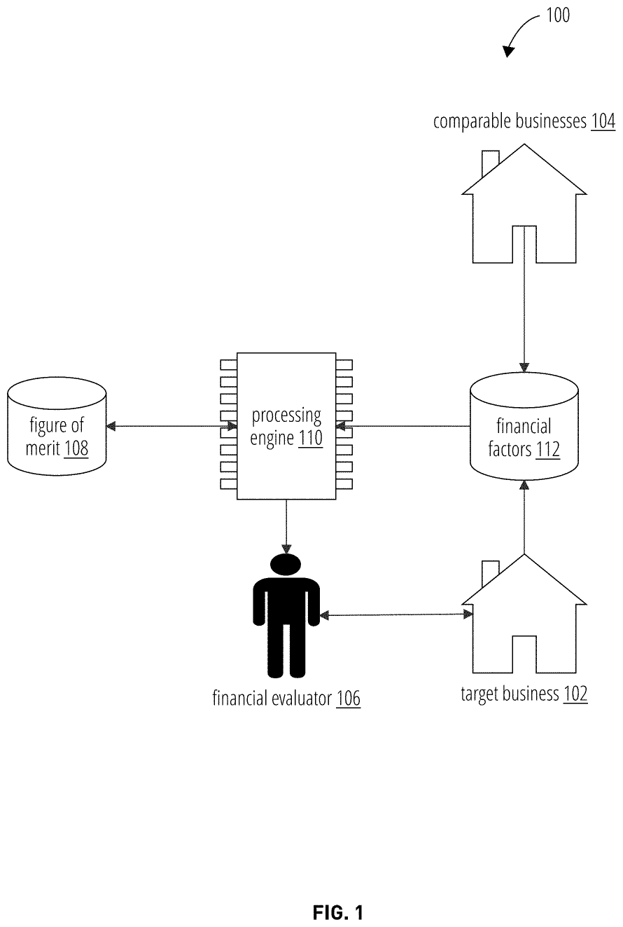

FIG. 1 provides a high-level system diagram 100 of an embodiment of the system. The financial factors 112 memory comprises of a scalar, vector and/or matrix time series of one or more financial measurements from several businesses of interest, encompassing the comparable businesses 104 and a target business 102. The target business 102 is the business applying for a loan and the focal point for the comparison and evaluation for the loan risk. The comparable businesses 104 are businesses that are similar and/or dissimilar to the target business 102 across many dimensions. The time series of financial measurements are analyzed within the processing engine 110 by a combination of several statistical algorithms to determine a figure of merit, which is stored in the figure of merit 108 memory. The figure of merit is then fed back into the processing engine 110 in order to provide a baseline distribution of the figures of merit for the target businesses. The figure of merit for the target business 102, can be determined as a percentile compared to the figures of merit for the comparable businesses 104. The figure of merit and its associated percentile are delivered to a financial evaluator 106, which may represent an analyst from the loan institution or an additional algorithm within the system, for risk evaluation, enabling the resolution of the appropriate level of capital and/or interest for a loan.

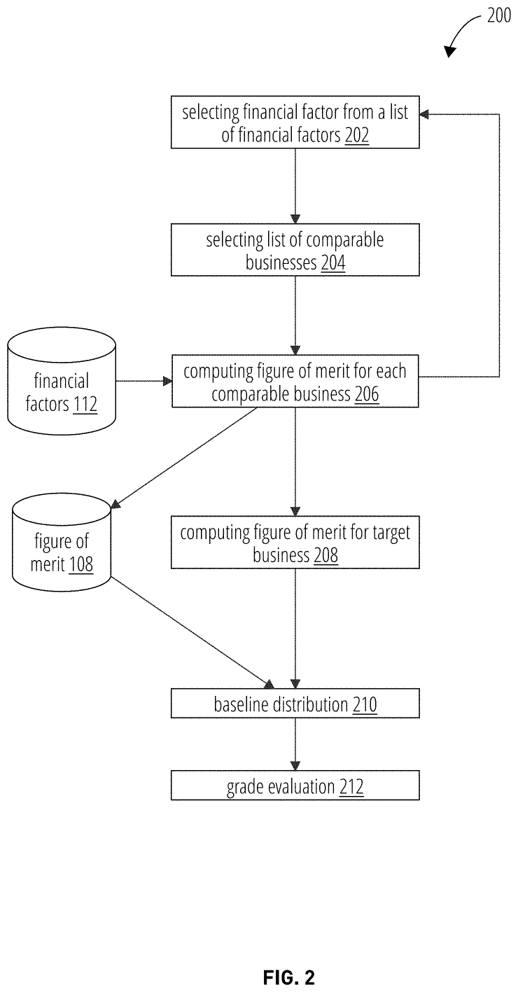

FIG. 2 gives an overview of the data flow 200 as used in one embodiment.

In block 202, a financial measurement is selected from a list of financial factors, such as, but not limited to, expenses, categories of sales and earnings, is performed.

In block 204, a business is selected from a list of comparable businesses matching a set of criteria, such as, but not limited to, geographical locations and business industry.

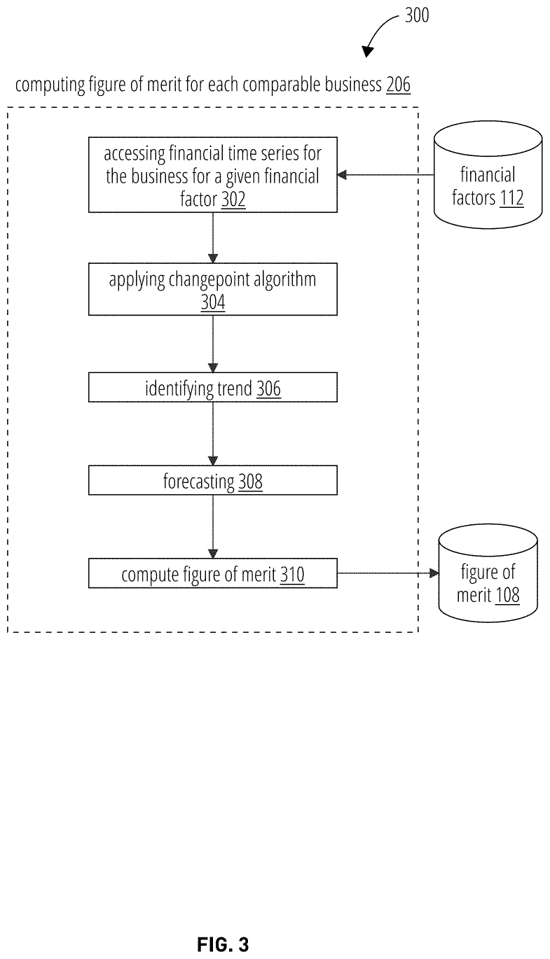

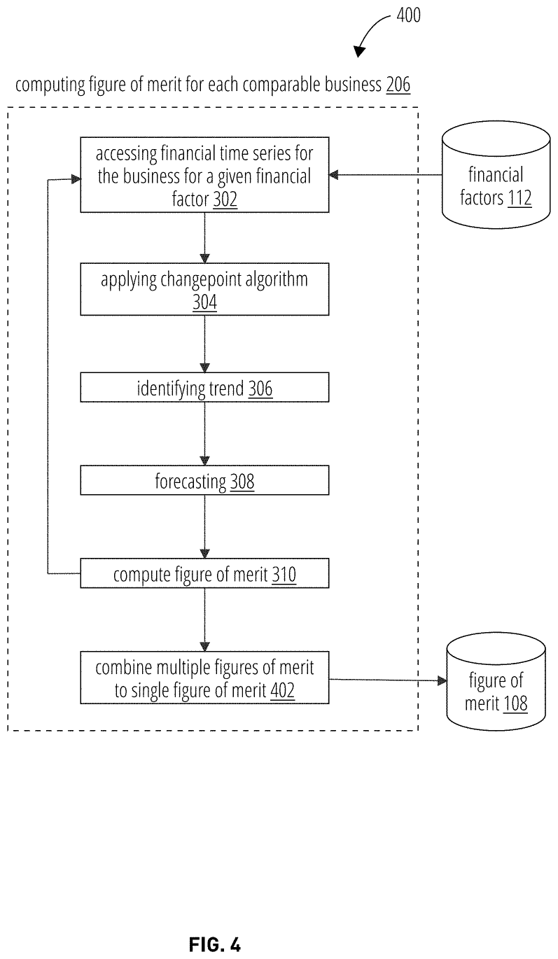

In block 206, the time series of a financial measurement for the comparable businesses selected is extracted from the financial factors 112 memory. A combination of algorithms are used in the computation of the figure of merit, which is stored in the figure of merit 108 memory, as per FIG. 3 for example. Additional financial factors can be analyzed by returning to block 202, as per FIG. 4 for example.

In block 208, similarly to that of the comparable businesses 104, the time series of a financial measurement for the target business selected is extracted from the financial factors 112 memory. Several algorithms are used in the computation of the figure of merit, which is stored in the figure of merit 108 memory, as per FIG. 3 for example. Additional financial factors can be analyzed by returning to block 202, as per FIG. 4 for example.

In block 210, using the comparable businesses 104 figures of merit and the target business 102 figure of merit from the figure of merit 108 memory, a baseline distribution 210 is compiled.

In block 212, the figure of merit for the target business 102 is compared to the comparable businesses 104 figure of merit in order to determine its percentile. The percentiles may be optionally binned into discrete buckets in order to simplify grade evaluation.

FIG. 3 gives an overview of the singular figure of merit computation 300 as used in one embodiment.

In block 302, financial time series for a selected business are extracted from the financial factors 112 memory.

In block 304, a changepoint detection algorithm is applied to the time series data set. A changepoint detection algorithm known in the art, such as, but not limited to, segmentation, structural breaks, break points, regime shifting, and detecting disorder can be employed to detect a single instance in a series of data, or multiple instances, where statistical properties differ before and after that instance.

In block 306, a trend detection algorithm is applied within the bounds of a single changepoint, or multiple changepoints, to the appropriate cluster, or clusters, of time series data. A trend detection algorithm known in the art, such as, but not limited to, fuzzy logic, statistical, regression, and wavelet techniques can be employed to detect a trend, or an underlying pattern of behavior in a single cluster, or multiple clusters, of time series data. Examples of trends include linear, logarithmic, exponential, moving average, power and polynomial.

In block 308, an extrapolation algorithm is applied to the relevant cluster of time series data. An extrapolation algorithm known in the art, such as, but not limited to, linear and polynomial extrapolation can be employed to predict a single data point, or multiple data points, outside of the bounds of the time series data.

In block 310, the figure of merit, such as, but not limited to, average monthly sales, a confidence interval for the average monthly sales, or any feature of distribution is determined and stored in the figure of merit 108 memory.

FIG. 4 gives an overview of the combined figures of merit computation 400 as used in one embodiment.

In block 310, the figure of merit is determined and outputted into block 402. Additional financial factors can be analyzed by returning to block 302 and receiving new input from the financial factors 112 memory.

In block 402, a collection of figures of merit are combined into a single figure of merit and outputted into the figure of merit 108 memory.

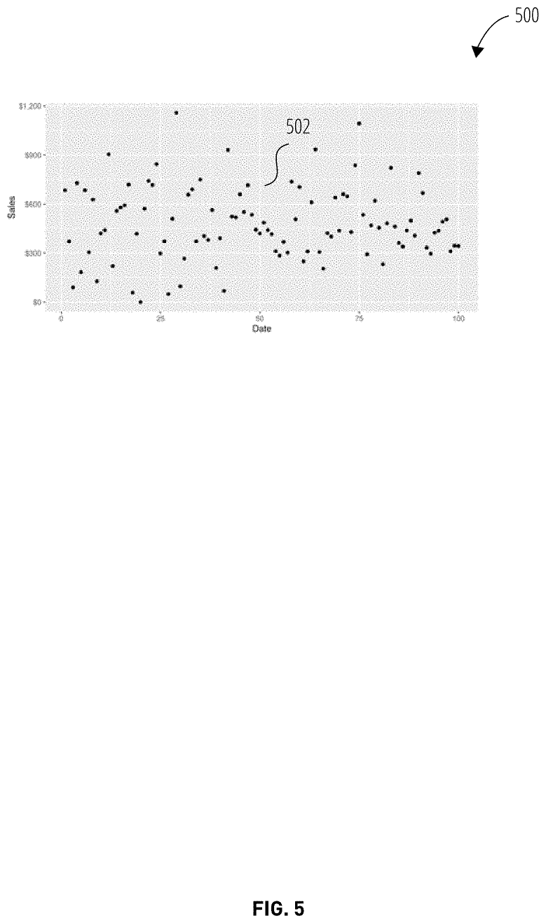

FIG. 5 illustrates the stable sales history 500 of a selected business. In this example, the sales of a business are plotted over a 100-date period, where the data is assumed to be stable and similar along the time series. An algorithm is applied to the sales data 502 in order to determine the figure of merit, which in this example is the average sales over the time series and is equal to $482.

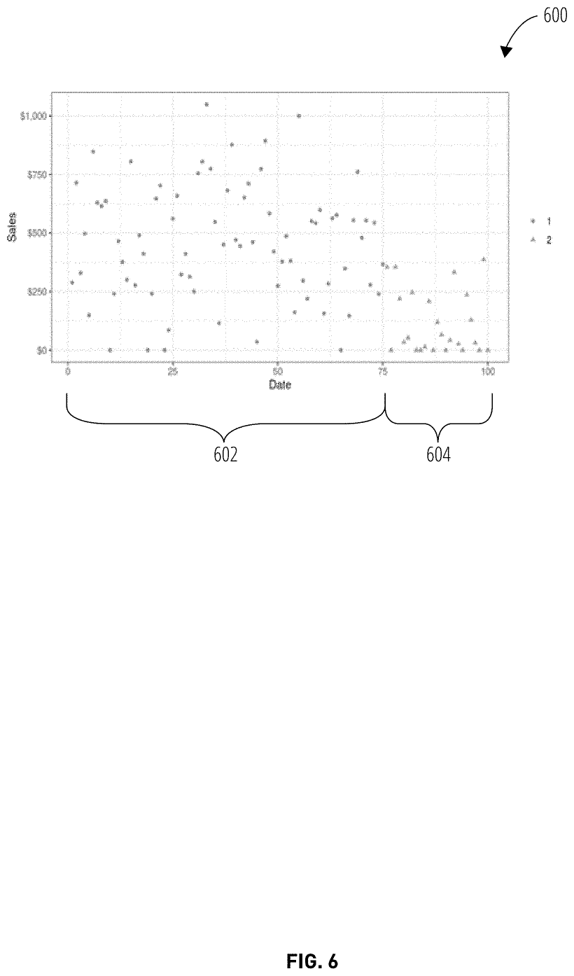

FIG. 6 illustrates an unstable sales history 600 of a selected business. In this example, the sales of a business are plotted over a 100-date period, where instability in the data is considered in the form of fluctuating operating hours. A changepoint detection algorithm is applied in this example to the sales data in order to determine stable and similar segments. Two separate segments are identified, operational during all regular business days 602 and nonoperational during some business days 604. The latter represents a restaurant closing for some non-busy days of the week, which implies lower sales as well as lower expenses, possibly resulting in increased profit. The previous section's algorithm is applied to obtain the average sales for when the restaurant closes during non-busy days of the week, which is equal to $114. This data can be used to better predict future sales and evaluate whether the business should receive a loan.

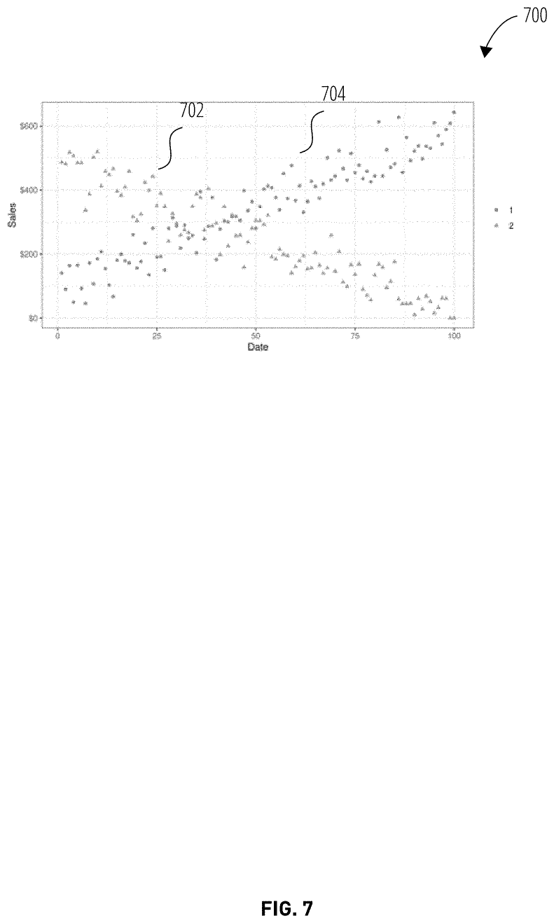

FIG. 7 illustrates different sales trends 700 of two selected businesses. In this example, two companies have exactly the same overall statistics as determined from the previous methods, but due to their differing trends they will likely have drastically different futures. As a solution, a regression analysis is performed on the two segments, growing sales data 704 and declining sales data 702, where the two segments are identified through the same process in the previous section. The regression analysis establishes a trend line and associated statistics.

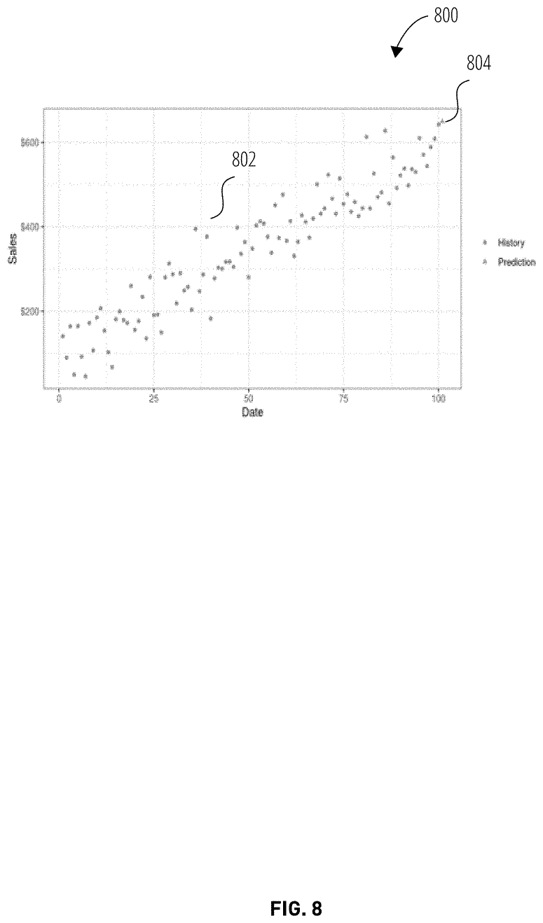

FIG. 8 illustrates sales forecasting 800 of a selected business. In this example, stable sales data 802 are identified and a regression analysis is performed through the same process as displayed in previous sections. The regression analysis establishes a trend line and associated statistics, which are used to extrapolate the data in order to form a prediction for the sales one-time unit into the future, displayed as the sales prediction 804. The sales prediction 804 is then used to calculate a figure of merit, which in this example would be $650. Other embodiments include but are not limited to extrapolating the data to form a prediction for the sales over multiple time units into the future.

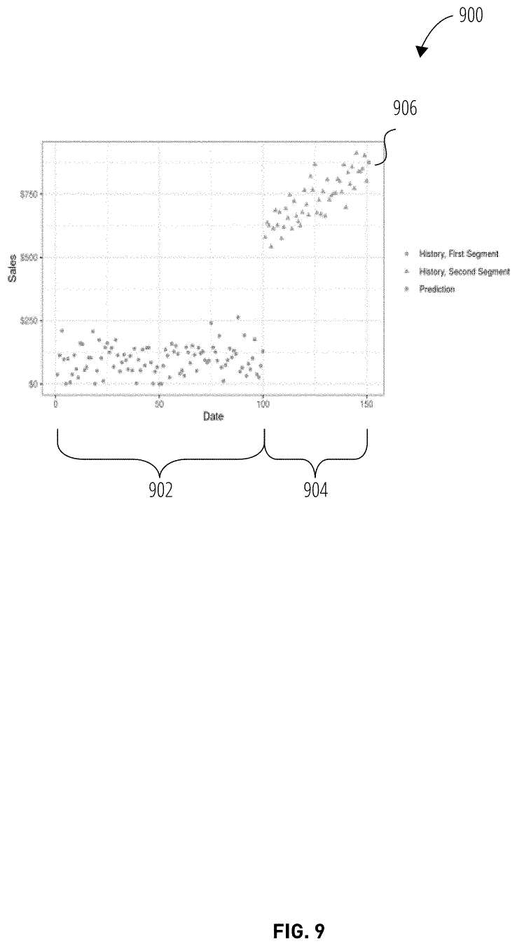

FIG. 9 gives an overview of the combined algorithm system 900 as used in one embodiment. In this example, all of the previous processes are combined in the determination of the figure of merit. The first historical segment, insignificant sales data 902, is removed from further calculations due to a drastic change in the sales data at date 100. The second historical segment, relevant sales data 904, is applied to the regression analysis where the determined trend line and associated statistics are used in the production of the sales forecast 906. The sales forecast 906 is then used to calculate the figure of merit, which in this example would be $875. Other embodiments include, but are not limited to, extrapolating the data to form a prediction for the sales of multiple time units into the future.

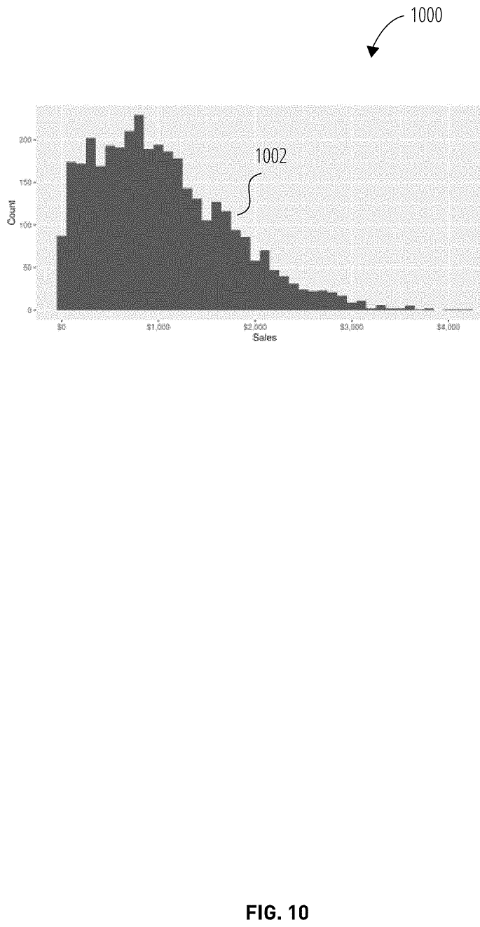

FIG. 10 gives an overview of the figure of merit histogram 1000 as used in one embodiment. In this example, the calculated figures of merit for all the businesses in the figure of merit 108 memory, figure of merit for all businesses 1002, are compiled into histogram and a baseline distribution is displayed.

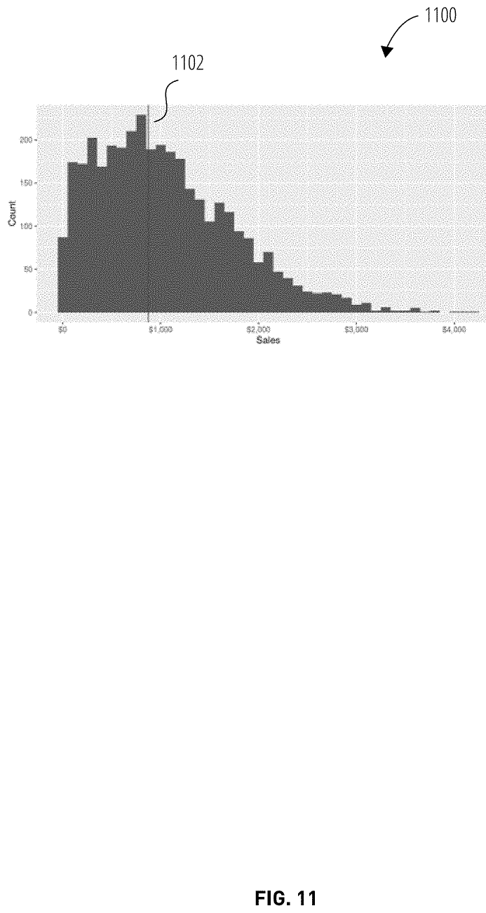

FIG. 11 gives an overview of the grade evaluation for target business 1100 as used in one embodiment. In this example, a baseline distribution of all Greek restaurants in Quebec with their monthly sales is displayed. The target business figure of merit 1102 is highlighted and determined to be in the 47th percentile with monthly sales of $875. Furthermore, additional embodiments include but are not limited to binning percentiles into groups. If the percentiles in this example were binned into five equally sized groups, the target business 102 would fall in the 3rd group (40-60%) and receive a corresponding grade.

As used herein, a “processing engine” or an “engine,” refers to a software implemented system that provides an output that is different from the input. An engine can be an encoded block of functionality, such as a platform, a library, an object or a software development kit (“SDK”). Each engine can be implemented on any type of computing device that includes one or more processors and computer readable media. Furthermore, two or more of the engines may be implemented on the same computing device, or on different computing devices. Non-limiting examples of a computing device include tablet computers, servers, laptop or desktop computers, music players, mobile phones, e-book readers, notebook computers, PDAs, smart phones, or other stationary or portable devices.

The processes and logic flows described herein can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). For example, the processes and logic flows can be performed by and apparatus can also be implemented as a graphics processing unit (GPU).

A computer program (which may also be referred to or described as a software application, code, a program, a script, software, a module or a software module) can be written in any form of programming language. This includes compiled or interpreted languages, or declarative or procedural languages. A computer program can be deployed in many forms, including as a module, a subroutine, a stand-alone program, a component, or other unit suitable for use in a computing environment. A computer program can be deployed to be executed on one computer or can be deployed on multiple computers that are located at one site or distributed across multiple sites and interconnected by a communication network.

Computers suitable for the execution of a computer program include, by way of example, general or special purpose microprocessors or both, or any other kind of central processing unit. Generally, a central processing unit receives instructions and data from a read-only memory or a random-access memory or both. A computer can also include, or be operatively coupled to receive data from, or transfer data to, or both, one or more mass storage devices for storing data, e.g., optical disks, magnetic, or magneto optical disks. It should be noted that a computer does not require these devices. Furthermore, a computer can be embedded in another device. Non-limiting examples of the latter include a game console, a mobile telephone a mobile audio player, a personal digital assistant (PDA), a video player, a Global Positioning System (GPS) receiver, or a portable storage device. A non-limiting example of a storage device include a universal serial bus (USB) flash drive.

Computer readable media suitable for storing computer program instructions and data include all forms of non-volatile memory, media and memory devices; non-limiting examples include magneto optical disks; semiconductor memory devices (e.g., EPROM, EEPROM, and flash memory devices); CD ROM disks; magnetic disks (e.g., internal hard disks or removable disks); and DVD-ROM disks. The processor and the memory can be supplemented by, or incorporated in, special purpose logic circuitry.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination. For example, each of the algorithms above can be replaced by more sophisticated algorithms with likely better performance at the cost of more complex coding, computation, and increased storage requirements. These more sophisticated algorithms can be plugged in as required.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

What is claimed is:

1. A method of evaluating financial risk for a target business against one or more comparable businesses, the method comprising of:
extracting a plurality of financial data for said target businesses from a financial factors memory;
applying a changepoint algorithm to determine one or more segments of said financial data;
identifying one or more trends within said one or more segments of financial time series data;
extrapolating said one or more trends to calculate one or more target figures of merit;
extracting one or more comparable figures of merit for said one or more comparable businesses from a figure of merit memory;
transforming said one or more comparable figures of merit into a baseline distribution;
determining a percentile for said target business within said baseline distribution;
storing said target figure of merit in said figure of merit memory.

2. The method of claim 1 wherein said financial data are comprised of a plurality of financial factors.

3. The method of claim 1 wherein said figure of merit is comprised of a plurality of previously calculated figures of merit.

4. The method of claim 1 wherein said percentiles are binned into a plurality of discrete buckets.

5. The method of claim 4 wherein said binned percentiles are awarded corresponding grades.

6. The method of claim 1 wherein said financial data is a time series.

7. The method of claim 1 wherein said financial data is a scalar.

8. A system of evaluating financial risk for a target business against one or more comparable businesses comprising of:
a financial factors memory storing a plurality of financial data for said target businesses;
a processor coupled to said financial factors memory;
wherein said processor executes a changepoint algorithm to determine one or more segments of said financial data and identifies one or more trends within said one or more segments of financial data then extrapolates said one or more trends to calculate one or more target figures of merit;
wherein said processor extracts one or more comparable figures of merit for said one or more comparable businesses from a figure of merit memory and transforms said one or more comparable figures of merit into a baseline distribution to determine a percentile for said target within said baseline distribution;
wherein said processor stores said target figure or merit in said figure of merit memory.

9. The system of claim 8 wherein said financial data are comprised of a plurality of financial factors.

10. The system of claim 8 wherein said figure of merit is comprised of a plurality of calculated figures of merit.

11. The system of claim 8 wherein said percentiles are binned into a plurality of discrete buckets.

12. The system of claim 11 wherein said binned percentiles are awarded corresponding grades.

13. The system of claim 8 wherein said financial data is a time series.

14. The system of claim 8 wherein said financial data is a scalar.
